(19) United States
(12) Patent Application Publication
(10) Pub. No.: US 2007/0082619 A1
(43) Pub. Date: Apr. 12, 2007

(54) METHOD AND APPARATUS FOR CONTROLLING DOWNLINK TRANSMISSION POWER FOR OFDMA BASED EVOLVED UTRA

(75) Inventors: Guodong Zhang, Farmingdale, NY (US); Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/537,773

(22) Filed: Oct. 2, 2006

Related U.S. Application Data
(60) Provisional application No. 60/724,338, filed on Oct. 6, 2005.

(51) Int. Cl. H04B 7/00; H04B 1/00

(52) U.S. Cl. 455/69; 455/522

(57) ABSTRACT

A method and apparatus for controlling downlink transmission power of signals transmitted from a serving base station to a wireless transmit/receive unit (WTRU) in a packet-switched data based system. The WTRU receives downlink pilot signals from the serving base station and a plurality of neighbor interfering cells. The WTRU measures the strength of the pilot signals associated with the neighbor interfering cells for which downlink transmission of the WTRU will be treated as intercell interference. The WTRU performs a channel quality indicator (CQI) measurement related to a received downlink pilot signal. The serving base station determines the transmission power of at least one of one of a downlink shared control channel and a downlink shared data channel established between the serving base station and the WTRU based on the CQI transmitted by the WTRU and an interference indicator received from at least one of a cell or a base station.

### CROSS REFERENCE TO RELATED APPLICATION

This application claims the benefit of U.S. Provisional Application No. 60/724,338 filed Oct. 6, 2005, which is incorporated by reference as if fully set forth.

### FIELD OF INVENTION

The present invention is related to a wireless communication system including a base station and at least one wireless transmit/receive unit (WTRU). More particularly, the present invention is related to downlink transmission power control for evolved universal terrestrial radio access (UTRA), which may be applicable to a single carrier frequency division multiple access (SC-FDMA) based system or an orthogonal frequency division multiple access (OFDMA) based system.

### BACKGROUND

In order to keep the technology competitive for a much longer time period, both Third Generation Partnership Project (3GPP) and 3GPP2 are considering implementing long term evolution (LTE), in which evolution of a radio interface and network architecture are necessary.

Currently, Currently, SC-FDMA and OFDMA are being considered for the implementation of the downlink of evolved UTRA. Packet-switched data should be supported efficiently in evolved UTRA. Downlink data, (i.e., both control data and user data), is transmitted on a shared channel. Therefore, the downlink transmission is not necessarily continuous, (in time). A properly designed downlink transmission power control (TPC) mechanism is needed to support this.

For a universal mobile telecommunications system (UMTS) wideband code division multiple access (WCDMA) downlink dedicated channel, a conventional closed-loop TPC mechanism is used. The conventional closed-loop TPC mechanism requires the history of downlink transmission power to one or more wireless transmit/receive units (WTRUs), and adjusts the downlink transmission power based on TPC commands received from the WTRU(s). However, the conventional closed-loop TPC mechanism cannot handle packet-switched data due to the discontinuous transmission. With discontinuous transmissions, the previous transmission power may be meaningless.

For UMTS high-speed downlink packet access (HSDPA) used in conventional wireless communication systems, a relatively fixed transmission power is used for high-speed downlink shared channel (HS-DSCH). For HSDPA, the intracell interference is the dominant factor. It is advantageous to keep received power at a WTRU of all intracell users roughly equal. According to the value of a channel quality indicator (CQI) reported by the WTRU, modulation coding scheme (MCS) and transport block size (TBS) are changed dynamically to keep the downlink transmission power of the WTRU fixed, except for the case when CQI is high. However, conventional mechanisms used for HSDPA are not suited for evolved UTRA where no or very little intracell interference exists.

### SUMMARY

The present invention is related to a method and apparatus for controlling downlink transmission power of signals transmitted from a serving base station to a WTRU in a packet-switched data based system. The WTRU receives downlink pilot signals from the serving base station and a plurality of neighbor interfering cells. The WTRU measures the strength of the pilot signals associated with the neighbor interfering cells for which downlink transmission of the WTRU will be treated as intercell interference. The WTRU performs a CQI measurement related to a received downlink pilot signal. The serving base station determines the transmission power of at least one of one of a downlink shared control channel and a downlink shared data channel established between the serving base station and the WTRU based on the CQI transmitted by the WTRU and an interference indicator received from at least one of a cell or a base station.

### BRIEF DESCRIPTION OF THE DRAWINGS

A more detailed understanding of the invention may be had from the following description, given by way of example and to be understood in conjunction with the accompanying drawings wherein:

FIG. 1 is a flowchart of a process for implementing TPC of a downlink shared control and data channel in a wireless communication system in accordance with the present invention; and

FIG. 2 is an exemplary block diagram of the wireless communication system in which the process of FIG. 1 is implemented.

### DETAILED DESCRIPTION OF THE PREFERRED EMBODIMENTS

Hereafter, a wireless transmit/receive unit (WTRU) includes but is not limited to a user equipment (UE), a mobile station, a fixed or mobile subscriber unit, a pager, or any other type of device capable of operating in a wireless environment. When referred to hereafter, a base station includes but is not limited to a Node-B, a site controller, an access point (AP) or any other type of interfacing device in a wireless environment.

The features of the present invention may be incorporated into an integrated circuit (IC) or be configured in a circuit comprising a multitude of interconnecting components.

Due to the fact that packet-switched data transmission may be discontinuous, the downlink transmission power control for evolved UTRA should be able to work without the history of transmission power.

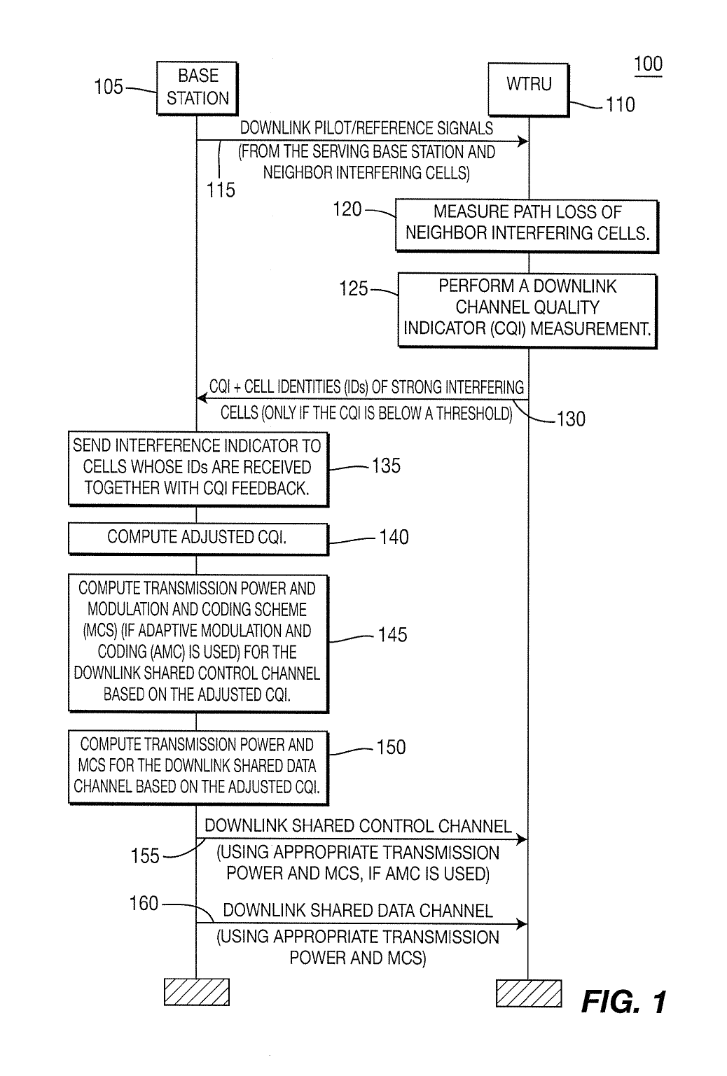

FIG. 1 shows a flowchart of a process 100 for implementing the TPC of a downlink shared control and data channel in a wireless communication system in accordance with the present invention. The wireless communication system includes a serving base station 105 and at least one WTRU 110.

In step 115, the WTRU 110 receives downlink pilot/reference signals from the serving base station 105 and neighbor interfering cells. In step 120, the WTRU 110 measures the downlink pilot strength, (corresponding to the path loss), for each neighbor interfering cell. The neighbor interfering cells associated with cell specific downlink pilots which downlink transmission to the WTRU 110 will be treated as intercell interference. If downlink intra-Node-B macro diversity is used in evolved UTRA, then the neighbor interfering cells of the WTRU 110 include all neighboring cells except the cells that are in the downlink active set of the WTRU 110, (i.e., downlink soft handover of the WTRU 110 is performed in these cells). Otherwise, the neighbor interfering cells of the WTRU 110 include all neighbor cells.

In step 125, the WTRU 110 measures the downlink CQI based on the received downlink pilot signals. Then, in step 130, the WTRU 110 reports CQI via the uplink shared control channel to the base station 105. Since downlink inter-base station, (i.e., inter-Node-B), macro diversity is not used in evolved UTRA, there is only one base station 105 that serves the WTRU 110 in the downlink. In step 130, the WTRU 110 may further report the cell identities (IDs) of the strong interfering neighbor cells having the N best path losses to the base station 105, together with the reported CQI, if the WTRU measured downlink CQI is below a predefined threshold. The value for N is a design parameter and is greater than or equal to one, (i.e., N≧1). The path loss is preferably below a predefined threshold, (i.e., close enough to the cell of interest), for the cell whose ID is reported.

In step 135, the base station 105 sends an interference indicator to the cell(s) corresponding to the cells ID(s) reported by the WTRU 110 if the base station 105 receives the reported CQI with cell ID(s) of strong neighbor interfering cell(s). The purpose of the interference indicator is to ask the strong neighbor interfering cell(s) to reduce transmission power appropriately and balance the load between cells. If the strong neighbor interfering cell is controlled by the same base station 105, then the interference indicator is communicated among cells via internal signaling within the same base station 105.

If the strong neighbor interfering cell is controlled by one or more other base stations, the base station 110 can send the interference indicator to cell(s) controlled by the other base station(s) via an interface between the base stations. Alternatively, the base station may send the interference indicator to cell(s) controlled by other base station(s) through an anchor point, preferably centralized, which connects the base stations.

In step 140, the base station 105 computes an adjusted CQI based on the reported CQI and the interference indicator. The adjusted CQI equals the CQI transmitted by the WTRU and then reduced by a predetermined parameter.

In step 145, the base station 105 determines the transmission power of both the downlink shared control channel and the downlink shared data channel based on the CQI reported by the WTRU 110 and an interference indicator sent by other cells/base stations, if any. Then, the base station 105 computes the transmission power of the downlink shared control channel by using a predetermined lookup table (LUT) that denotes the relationship between the adjusted CQI, the required transmission power and the MCS of the shared control channel, (only if adaptive modulation and coding (AMC) is used for the downlink shared control channel), in order to meet the required performance.

Similarly, in step 150, the base station 105 computes the transmission power of the downlink shared data channel by using a predetermined lookup table that denotes the relationship between the adjusted CQI, the required transmission power and the MCS of the shared data channel, in order to meet the required performance.

In steps 155 and 160, the base station 105 transmits the downlink shared control channel and the downlink shared data channel using the determined transmission power and the MCS.

In the case where transmission occurs only on the downlink shared control channel and there is no transmission on downlink shared data channel, the downlink transmission power control mechanism may still be applied without the base station 105 computing transmission power or MCS for the downlink shared data channel.

The present invention responds to fast fading without the history of the transmission power. Therefore, the present invention handles packet-switched traffic in evolved UTRA in an efficient and seamless manner.

The above method may be implemented in a WTRU or a base station at the data link layer, the network layer and the physical layer on the digital baseband. Possible implementations include application specific integrated circuit (ASIC), digital signal processor (DSP), software and hardware. The applicable air interface includes 3GPP LTE.

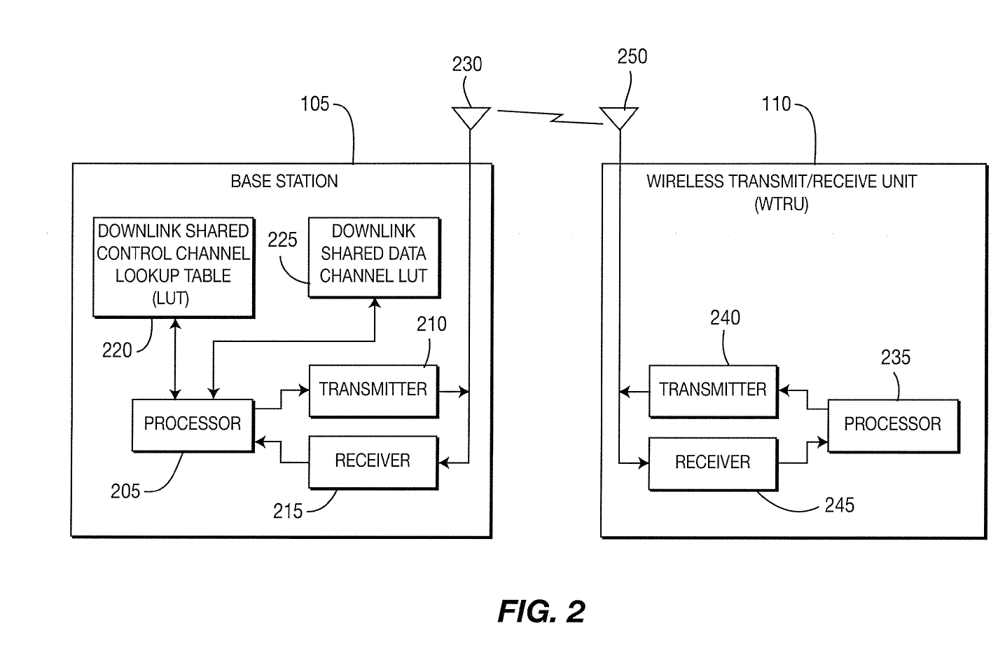

FIG. 2 is an exemplary block diagram of the wireless communication system in which the process 100 of FIG. 1 is implemented. The wireless communication system shown in FIG. 2 includes the base station 105 and at least one WTRU 110. The base station 105 includes a processor 205, a transmitter 210, a receiver 215, a downlink shared control channel LUT 220, a downlink shared data channel LUT 225 and an antenna 230. The WTRU 110 includes a processor 235, a transmitter 240, a receiver 245 and an antenna 250.

The transmitter 210 in the base station 105 transmits a downlink pilot signal to the WTRU 110. The receiver 245 in the WTRU 110 receives the downlink pilot signal from the transmitter 210 and downlink pilot signals from neighbor interfering cells via the antenna 250. The processor 235 in the WTRU 110 measures the path loss of the neighbor interfering cells and performs a downlink CQI measurement based on the received downlink pilot signals. The transmitter 240 in the WTRU 110 transmits the CQI via the antenna 250 over an uplink shared control channel to the base station 105. The transmitter 240 in the WTRU 110 may further transmit the cell identities (IDs) of the neighboring cells having the N best path losses to the base station 105 together with the CQI, if the processor 235 in the WTRU 110 determines that the measured downlink CQI is below a predefined threshold.

The transmitter 210 of the base station 105 sends an interference indicator to the cell(s) corresponding to the cells ID(s) reported by the WTRU 110 if the receiver 215 of the base station 105 receives the reported CQI with cell ID(s) of strong neighbor interfering cell(s). The processor 205 in the base station 105 computes an adjusted CQI based on the reported CQI and the interference indicator. The processor 205 in the base station 105 determines the transmission power of both the downlink shared control channel and the downlink shared data channel based on the CQI reported by the WTRU 110 and an interference indicator sent by other cells/base stations, if any. Then, the processor 205 in the base station 105 computes the transmission power of the downlink shared control channel by using the downlink shared control channel LUT 220, which denotes the relationship between the adjusted CQI, the required transmission power and the MCS of the shared control channel, (only if adaptive modulation and coding (AMC) is used for the downlink shared control channel), in order to meet the required performance.

Similarly, the processor 205 in the base station 105 computes the transmission power of the downlink shared data channel by using the downlink shared data channel LUT 225, which denotes the relationship between the adjusted CQI, the required transmission power and the MCS of the shared data channel, in order to meet the required performance.

The transmitter 210 in the base station 105 transmits the downlink shared control channel and the downlink shared data channel to the WTRU 110 using the determined transmission power and the MCS.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method of controlling downlink transmission power of signals transmitted from a serving base station to a wireless transmit/receive unit (WTRU) in a packet-switched data based system having a plurality of neighbor cells, the method comprising:
the WTRU receiving downlink pilot signals from the serving base station and the plurality of neighbor cells;
the WTRU measuring the strength of the pilot signals associated with neighbor cells for which downlink transmission of the WTRU will be treated as intercell interference;
the WTRU performing a channel quality indicator (CQI) measurement related to a received downlink pilot signal;
the WTRU transmitting a CQI and the identities of strong interfering cells to the base station; and
the serving base station determining the transmission power of at least one of one of a downlink shared control channel and a downlink shared data channel established between the serving base station and the WTRU based on the CQI transmitted by the WTRU and an interference indicator received from at least one of a cell or a base station.

2. The method of claim 1 further comprising:
the base station adjusting the CQI received from the WTRU; and
the base station determining a transmission power and modulation and coding scheme (MCS) for the downlink shared control channel based on the adjusted CQI.

3. The method of claim 2 wherein the base station determines the transmission power of the downlink shared control channel by using a lookup table (LUT) that denotes the relationship between the adjusted CQI, a required transmission power and the MCS.

4. The method of claim 1 further comprising:
the base station adjusting the CQI received from the WTRU; and
the base station determining a transmission power and modulation and coding scheme (MCS) for the downlink shared data channel based on the adjusted CQI.

5. The method of claim 4 wherein the base station determines the transmission power of the downlink shared data channel by using a lookup table (LUT) that denotes the relationship between the adjusted CQI, a required transmission power and the MCS.

6. The method of claim 1 wherein the WTRU transmits the identities of the strong interfering cells to the base station only if the CQI measurement is below a predefined threshold.

7. The method of claim 1 wherein the WTRU transmits the identities of neighboring cells having the N best path losses to the base station only if the CQI measurement is below a predefined threshold.

8. The method of claim 7 wherein N is a design parameter which is greater than or equal to one.

9. The method of claim 1 wherein the packet-switched data based system is an orthogonal frequency division multiple access (OFDMA) system.

10. A packet-switched data based system comprising:
a serving base station;
a plurality of neighbor cells; and
a wireless transmit/receive unit (WTRU), the WTRU receives downlink pilot signals from the serving base station and the plurality of neighbor cells, the WTRU measures the strength of pilot signals associated with neighbor cells for which downlink transmission of the WTRU will be treated as intercell interference, the WTRU performs a channel quality indicator (CQI) measurement related to a received downlink pilot signal, the WTRU transmits a CQI and the identities of strong interfering cells to the serving base station, and the serving base station determines the transmission power of at least one of one of a downlink shared control channel and a downlink shared data channel established between the serving base station and the WTRU based on the CQI transmitted by the WTRU and an interference indicator received from at least one of a cell or a base station.

11. The system of claim 10 wherein the base station adjusts the CQI received from the WTRU, and the base station determines a transmission power and modulation and coding scheme (MCS) for the downlink shared control channel based on the adjusted CQI.

12. The system of claim 10 wherein the base station determines the transmission power of the downlink shared control channel by using a lookup table (LUT) that denotes the relationship between the adjusted CQI, a required transmission power and the MCS.

13. The system of claim 10 wherein the base station adjusts the CQI received from the WTRU, and the base station determines a transmission power and modulation and coding scheme (MCS) for the downlink shared data channel based on the adjusted CQI.

14. The system of claim 13 wherein the base station determines the transmission power of the downlink shared data channel by using a lookup table (LUT) that denotes the relationship between the adjusted CQI, a required transmission power and the MCS.

15. The system of claim 10 wherein the WTRU transmits the identities of the strong interfering cells to the base station only if the CQI measurement is below a predefined threshold.

16. The system of claim 10 wherein the WTRU transmits the identities of neighboring cells having the N best path losses to the base station only if the CQI measurement is below a predefined threshold.

17. The system of claim 16 wherein N is a design parameter which is greater than or equal to one.

18. The system of claim 10 wherein the packet-switched data based system is an orthogonal frequency division multiple access (OFDMA) system.

19. A base station comprising:
a receiver for receiving a channel quality indicator (CQI) and the identities of strong interfering cells from a wireless transmit/receive unit (WTRU); and
a processor electrically coupled to the receiver for determining the transmission power of at least one of one of a downlink shared control channel and a downlink shared data channel established between the base station and the WTRU based on the CQI transmitted by the WTRU and an interference indicator received from at least one of a cell or a base station, wherein the processor computes an adjusted CQI based on the CQI transmitted by the WTRU and the interference indicator;
a first lookup table (LUT) electrically coupled to the processor which denotes the relationship between the adjusted CQI, a required transmission power and the MCS of the downlink shared control channel;
a second LUT electrically coupled to the processor which denotes the relationship between the adjusted CQI, a required transmission power and the MCS of the downlink shared data channel; and
a transmitter electrically coupled to the processor for transmitting at least one of the downlink shared control channel and the downlink shared data channel to the WTRU using the determined transmission power and the MCS.

20. An integrated circuit (IC) embedded in a base station, the IC comprising:
a receiver for receiving a channel quality indicator (CQI) and the identities of strong interfering cells from a wireless transmit/receive unit (WTRU); and
a processor electrically coupled to the receiver for determining the transmission power of at least one of one of a downlink shared control channel and a downlink shared data channel established between the base station and the WTRU based on the CQI transmitted by the WTRU and an interference indicator received from at least one of a cell or a base station, wherein the processor computes an adjusted CQI based on the CQI transmitted by the WTRU and the interference indicator;
a first lookup table (LUT) electrically coupled to the processor which denotes the relationship between the adjusted CQI, a required transmission power and the MCS of the downlink shared control channel;
a second LUT electrically coupled to the processor which denotes the relationship between the adjusted CQI, a required transmission power and the MCS of the downlink shared data channel; and
a transmitter electrically coupled to the processor for transmitting at least one of the downlink shared control channel and the downlink shared data channel to the WTRU using the determined transmission power and the MCS.

21. A wireless transmit/receive unit (WTRU) comprising:
a receiver for receiving downlink pilot signals from a serving base station and a plurality of neighbor cells;
a processor electrically coupled to the receiver, the processor for measuring the strength of pilot signals associated with neighbor cells for which downlink transmission of the WTRU will be treated as intercell interference, and for performing a channel quality indicator (CQI) measurement related to a received downlink pilot signal; and
a transmitter electrically coupled to the processor, the transmitter transmitting a CQI and the identities of strong interfering cells to the base station, wherein the transmitter transmits the identities of the strong interfering cells to the base station only if the CQI measurement is below a predefined threshold.

22. An integrated circuit embedded in a wireless transmit/receive unit (WTRU), the IC comprising:
a receiver for receiving downlink pilot signals from a serving base station and a plurality of neighbor cells;
a processor electrically coupled to the receiver, the processor for measuring the strength of pilot signals associated with neighbor cells for which downlink transmission of the WTRU will be treated as intercell interference, and for performing a channel quality indicator (CQI) measurement related to a received downlink pilot signal; and
a transmitter electrically coupled to the processor, the transmitter transmitting a CQI and the identities of strong interfering cells to the base station, wherein the transmitter transmits the identities of the strong interfering cells to the base station only if the CQI measurement is below a predefined threshold.
